(19) United States
(12) Patent Application Publication
(10) Pub. No.: US 2017/0010770 A1
(43) Pub. Date: Jan. 12, 2017

(54) METHOD AND APPARATUS FOR ORGANIZING, STAMPING, AND SUBMITTING PICTORIAL DATA

(71) Applicant: Ustringer LLC, Lake Oswego, OR (US)

(72) Inventor: Marty Mianji, Lake Oswego, OR (US)

(21) Appl. No.: 15/275,171

(22) Filed: Sep. 23, 2016

Related U.S. Application Data
(63) Continuation of application No. 14/120,193, filed on May 5, 2014, now abandoned.
(60) Provisional application No. 61/817,852, filed on Apr. 30, 2013.

(51) Int. Cl. G06F 3/0482; G06T 11/60; G06T 11/20; G06F 17/24; H04L 29/08; G06F 3/16

(52) U.S. Cl. CPC G06F 3/0482; H04L 67/18; G06F 3/167; G06T 11/203; G06F 17/24; G06T 11/60

(57) ABSTRACT

Some embodiments of the invention provide a method for organizing, stamping, and submitting pictorial data. In some embodiments, a stamping mechanism is provided that allows a user to create stamp chains for stamping pictorial data. In some embodiments, a sketching mechanism is also provided that allows a user to add input through sketching pictorial data. In some embodiments, a proposal mechanism is also provided to allow a user or other entity to propose a new stamp to add to the application.

### CLAIM OF BENEFIT TO PRIOR APPLICATION

This application claims the benefit of U.S. Provisional Application 61/817,852, entitled “Method and Apparatus for Organizing, Stamping, and Submitting Pictorial Data”, filed Apr. 30, 2013, which is incorporated herein by reference.

### BACKGROUND

The dominant public-facing Internet applications have varying notions of how they view conversations. For instance, some public-facing Internet Applications chiefly act as the facilitators of conversations between its user communities where individual and corporate voices may mix (e.g. Facebook), some primarily have a question-centric view of conversations between itself and its users (e.g. Google), and some merely act as a multicast channel through which individuals and corporations may be heard (e.g. Twitter).

However, conversations aren't always necessarily about search, nor should they be limited to exchanges between groups of individuals who already know one another. Thus far, conversations that take place in web-based applications and over mobile devices have also been predominantly linguistically based. Photographs and the ability to sketch on them are a natural, seamless and language-agnostic form of communication that can remove linguistic barriers and facilitate more efficient conversations. Furthermore, organizing conversations around activities is needed to bring clarity to every conversation and multicasting conversations through social media will allow an application to leverage both networks of data and the wisdom of crowds in order to conduct more meaningful conversations.

### BRIEF SUMMARY

Some embodiments of the invention provide a method for organizing, stamping, and submitting pictorial data. In some embodiments, this method is implemented using a mobile device application with graphical user interface (GUI) tools. In some embodiments, stamping mechanisms and free-sketching mechanisms are provided to add pictorial data input to a photographic image to organize and communicate sentiments related to the image. Some embodiments require that input be added to a photographic image before it can be submitted to the application server for processing and multicasting. Where no user added input is added, the application will prompt the user to add input using machine-prompted queries.

Some embodiments provide a stamping mechanism to add input on a photographic image taken in near-real time or selected from a collection of stored photographic images on the mobile device. In some embodiments, this stamping mechanism includes a means to select different types of stamps to organize and communicate sentiments about the photographic image. Different types of stamps include but are not limited to universal stamps, activity-specific stamps, and operator stamps. Operator stamps in some embodiments allow the users to create stamp chains to communicate a relationship between the stamps and meaning to the photographic image.

Some embodiments provide a sketching mechanism to add input on a photographic image taken in near-real time or selected from a collection of stored photographic images on the mobile device. In some embodiments, this sketching mechanism includes a means to select different colors and draw freehand lines, shapes, symbols, words, etc.

Some embodiments provide a proposal mechanism for users and entities (e.g. people, companies, organizations, etc) to sketch new stamps they would like to see added to the application. New stamp proposal drawings in some embodiments must be accompanied by spoken or written text explaining the proposed new stamp (e.g. describe what activity the stamp is proposed for, describe what the stamp means, etc.). In some embodiments, implementation of proposed new stamps will be passed based on voting by other users and entities. In some other embodiments, a special category of proposed new stamps allows for the creation of sponsored stamps that are not dependent on the voting process if a fee is paid.

The preceding Brief Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Brief Summary as well as other embodiments. Accordingly, to understand all the embodiments described in this document, a full review of the Brief Summary, Detailed Description and the Drawings is needed. Moreover, the claimed subject matters are not to be limited to the illustrative details in the Brief Summary, Detailed Description and the Drawings, but rather are to be defined by the appended claims because the claimed subject matters can be embodied in other specific forms without departing from the spirit of the subject matters.

### BRIEF DESCRIPTION OF THE DRAWINGS

The novel features of the invention are set forth in the appended claims. However, for the purpose of explanation, several embodiments of the invention are set forth in the following figures.

FIG. 1 illustrates an example graphical user interface (“GUI”) at first glance for an example application of some embodiments of the invention.

FIG. 2 illustrates an example GUI after a photographic image has been captured.

FIG. 3 illustrates an input prompt GUI when no user input is detected by the application when an image is submitted, to the application.

FIG. 4 illustrates an example comment GUI.

FIG. 5 illustrates an example stamp tools input GUI.

FIG. 6 illustrates an example color tool input GUI.

FIG. 7 illustrates an example GUI after input selection has been added.

FIG. 8 conceptually illustrates how some embodiments determine what activity-specific stamps to display in the stamp tools input GUI based on geo-location.

FIG. 9 illustrates an example GUI after input selection has been added.

FIG. 10 illustrates an example confirmation GUI after pictorial data has been submitted to the application server.

FIG. 11 illustrates an example mobile device photo gallery GUI.

FIG. 12 illustrates an example GUI after input selection has been added.

FIG. 13 illustrates an example confirmation GUI after pictorial data has been submitted to the application server.

FIG. 14 illustrates an example GUI after input selection has been added.

FIG. 15 illustrates an example comment GUI.

FIG. 16 illustrates an example comment GUI for adding written text.

FIG. 17 illustrates an example comment GUI for adding spoken text.

FIG. 18 illustrates an example sketching GUI for proposing new stamps.

FIG. 19 illustrates an example sketching GUI for proposing new stamps.

FIG. 20 illustrates an example comment GUI.

FIG. 21 illustrates an example comment GUI for adding written text.

FIG. 22 illustrates an example comment GUI for adding spoken text.

FIG. 23 illustrates an example confirmation GUI after a new stamp proposal has been submitted.

FIG. 24 illustrates a system by which some embodiments are implemented.

### DETAILED DESCRIPTION

In the following detailed description of the invention, numerous details, examples, and embodiments of the invention are set forth and described. However it will be clear and apparent to one skilled in the art that the invention is not limited to the embodiments set forth and that the invention may be practiced without some of the specific details and examples discussed below.

Some embodiments of the invention implement a method for conveying and submitting pictorial data. In some embodiments, pictorial data refers to primarily photographic images, but one skilled in the art will understand that it is not limited to this and may also include free-form sketch images and any associated written spoken words, among other things. A person skilled in the art will also understand that “image,” “photographic image,” “data,” and “pictorial data” may be used interchangeably where appropriate. In some embodiments, a photographic image may not be submitted without first adding sentiment to convey context and meaning in the image, and prepare the pictorial data to be organized in storage and disseminated to communicate a remark or a question. These inputs may be either machine prompted or user generated. Some examples of user-generated inputs include free-form sketching on the photographic image, adding pre-defined stamps, or combining one or both of them with one or more operators to create a stamp chain to convey a remark or query.

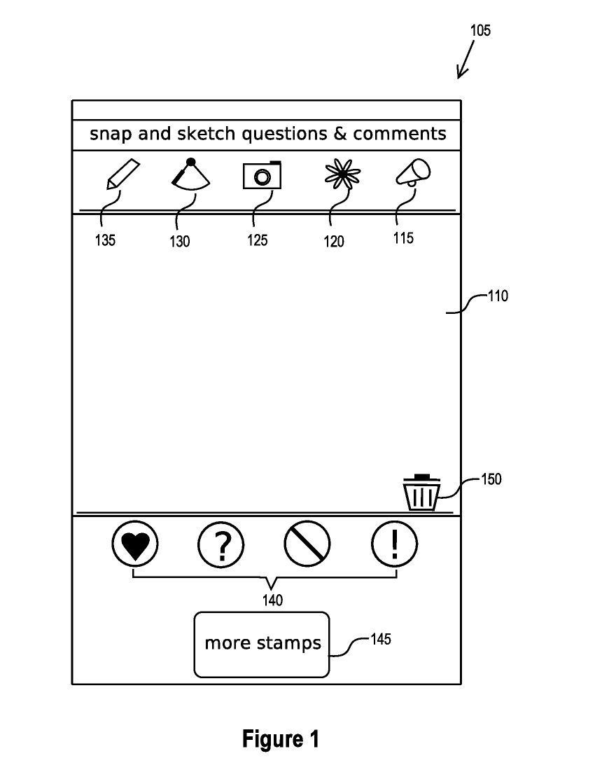

Some embodiments of the invention implement a method for conveying and submitting pictorial data in near-real time through an example client mobile device application using a graphical user interface (“GUI”) to convey and submit pictorial data in near-real time. FIGS. 1-7 and 9-23 illustrate various example GUIs of an example application of some embodiments of the invention for a specific example activity, shopping. This example application implements a GUI for capturing images, using previously captured images, adding inputs, and submitting all the data to the application for processing. It also implements a GUI for selecting and displaying input tools based on geo-location.

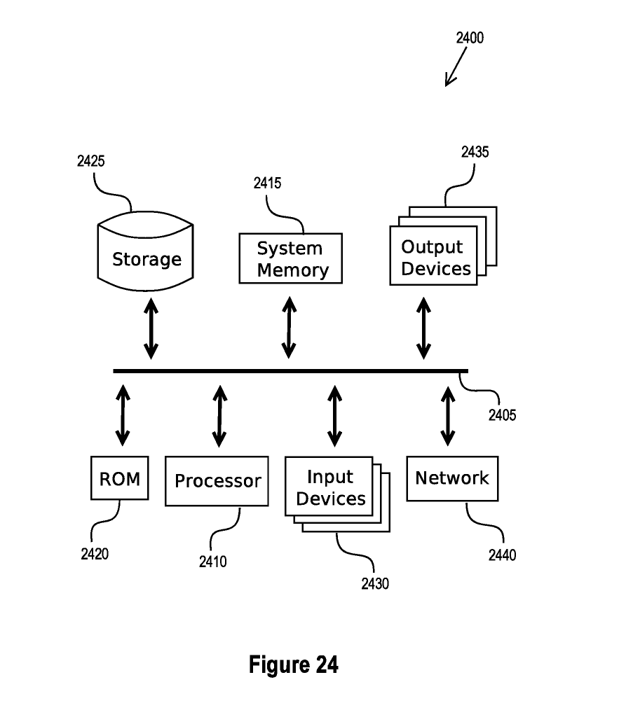

While some embodiments show these processes implemented on an example mobile device interface for a specific activity, shopping, one of ordinary skill in the art will realize that many of these processes can be used together or separately in many other types of activities as well as arenas. In addition, these processes can be used with client applications on any platform, system, or device. For example, the client application can be used on smartphones, tablets, web browsers, and desktop clients. Some embodiments of the relationship between the application system architecture, network, and server will be further discussed below in FIG. 24.

### I. Submitting Pictorial Data Without User Added Input

FIG. 1 illustrates an example GUI 105 that some embodiments of the invention automatically generate and display when a user opens the example mobile device application. In some embodiments, GUI 105 also includes: Image Creator Box 110; Action Buttons 115, 120, 125, 130, and 135; Stamp Tools 140; More Stamps Button 145; and Stamp Eraser Tool 135.

In the example of FIG. 1, Action Buttons 115, 120, 125, 130, and 135 are individual touch-selectable buttons and communicate user commands to the application. Action Button 115 prompts the application to submit the pictorial date in Image Creator Box 110 to the application server for processing; Action Button 120 prompts the application to pull up a collection of photos already on the application device (e.g. mobile phone device's photo gallery) so the user can select an existing photo to add to Image Creator Box 110; Action Button 125 prompts the application to capture a photographic image and display it in Image Creator Box 110; Action Button 130 prompts the application to erase all added input in Image Creator Box 110 except for stamps; and Action Button 135 prompts the application to display an input tools GUI. One of ordinary skill in the art will understand that the touch-selectable buttons may be displayed in any other arrangement (e.g. drop down menu, rollover display menu, etc.) and may include other Action Buttons as well.

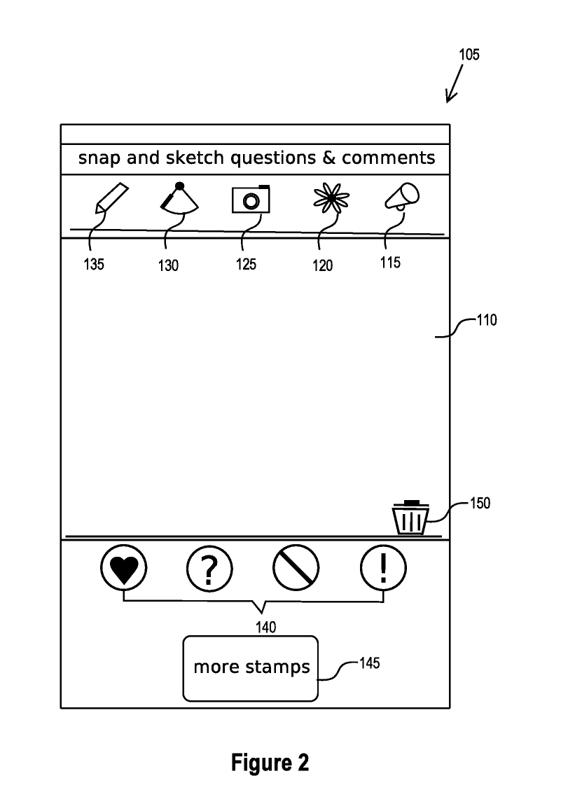

FIG. 2 illustrates GUI 105 after the user selects Action Button 125 in FIG. 1 and takes a photo. In some embodiments, selecting Action Button 125 prompts the application to snap a photographic image using the built in camera on the user's mobile device and display it in Image Creator Box 110. In some embodiments, the user may select Action button 135, one or more of Stamp Tools 140, or More Stamps Button 145 to add user input to the photographic image displayed in Image Creator Box 110 before submitting it to the application using Action Button 115.

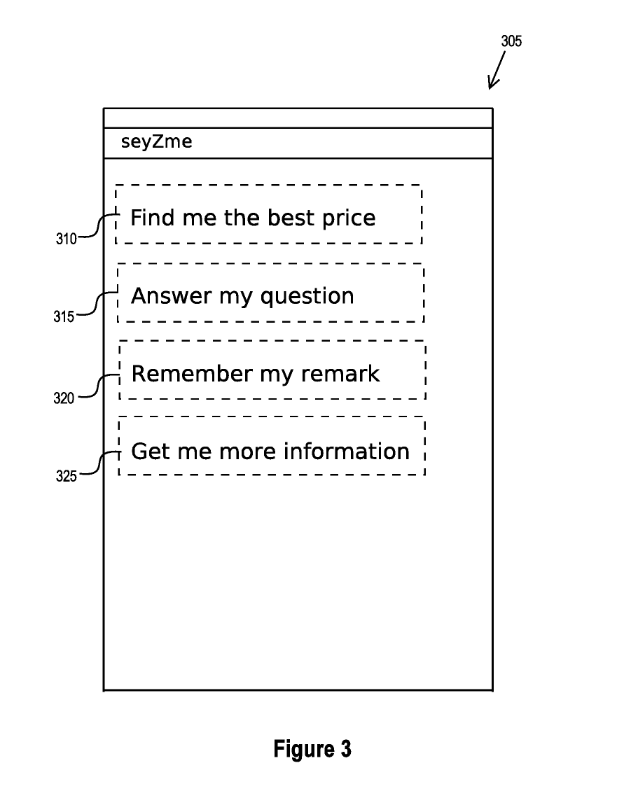

FIG. 3 illustrates an example Input Prompt GUI 305 that is displayed if the user selects Action Button 115 to submit the pictorial data in Image Creator Box 110 without first adding any other inputs on the photographic image using Action button 135, Stamp Tools 140, or More Stamps Button 145. In some embodiments, this prompts the application to display GUI 305 and a list of touch-selectable machine-generated queries to determine what information to associate with the photographic image. In other words, some embodiments may not allow a photographic image to be submitted if no additional input is first added on the photographic image.

In some embodiments, there are two types of machine-generated queries: input-necessary queries and input-optional queries. In example GUI 305, four different machine-generated queries are displayed: input-optional query 310, input-necessary query 315, input-necessary query 320, and input-optional query 325. In some embodiments, the list of machine-generated queries that is displayed is dynamic and activity-based and may include a different combination of and/or number of machine-generated queries each time. One of ordinary skill in the art will understand that the touch-selectable list may also be displayed in any other arrangement (e.g. drop down list, rollover display list, etc.).

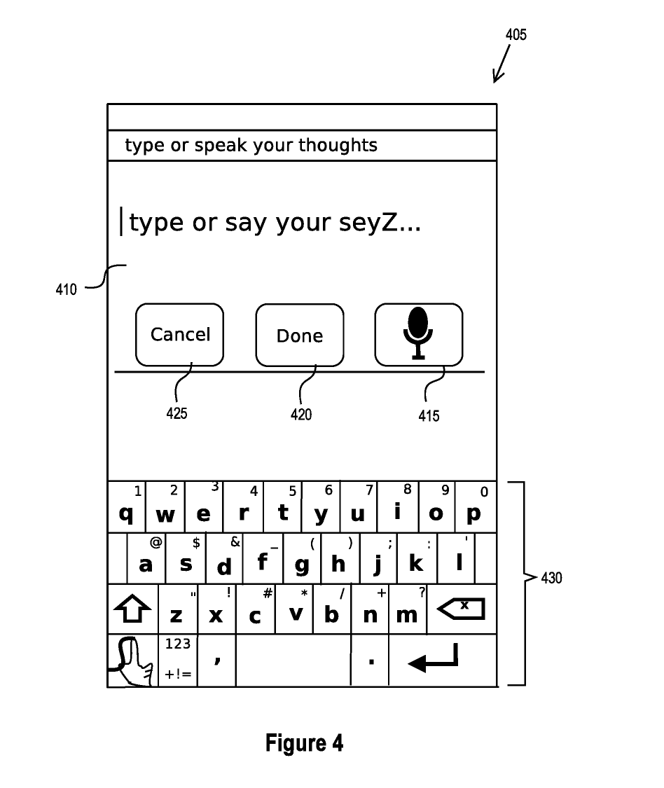

In some embodiments, selection of input-necessary queries will require the user to add a comment input to the query selection. For example, FIG. 4 illustrates an example comment GUI 405 that is displayed when the user selects input-necessary query 320. In some embodiments, input can be added using either written or spoken text.

In the example of FIG. 4, the user can touch Text Box 410 to input written text or select Talk Button 415 to input spoken text. In some embodiments, touching Text Box 410 prompts the application to display a touch screen keyboard Tool GUI 430 for inputting text in GUI 405. In the example of FIG. 4, the user can select Talk Button 415 and say “I don't like this mouse” to convey that remark as a sentiment using the example application device's built in mobile device microphone that can process natural language into text.

In some embodiments, selecting Done Button 420 will send the photographic image with added sentiment to the application server for processing. In some embodiments, GUI 405 will also display a Cancel Button 425 that the use can select at any time to prompt the application to display GUI 305 again from FIG. 3.

### II. Submitting Pictorial Data With User Added Input

Returning to the example in FIG. 2, the user can add input to the photographic image in Image Creator Box 110 by selecting Action Button 135, Stamp Tools 140, or More Stamps Button 145. In some embodiments, Action Button 135, Stamp Tools 140, and More Stamps Buttons 145 are touch-selectable buttons that the user can select to add either remark-type sentiments or question-type sentiments onto a photographic image through either stamping or free-form sketching.

In some embodiments the user can use the input tools by selecting a stamp from Stamp Tools 140 or More Stamps Button 145 and adding it to the photographic image in Image Creator Box 110 using the user's finger on a touch screen interface, or by selecting Action Button 135 and free-form sketching input onto the photographic image in Creator Box 110 using the user's finger on a touch screen interface. In some embodiments, only stamp tools may be used to add input to the photographic image in Image Creator Box 110. In some other embodiments, only free-form sketching may be used. In some other embodiments still, a combination of both stamp tools and free-form sketching may be used.

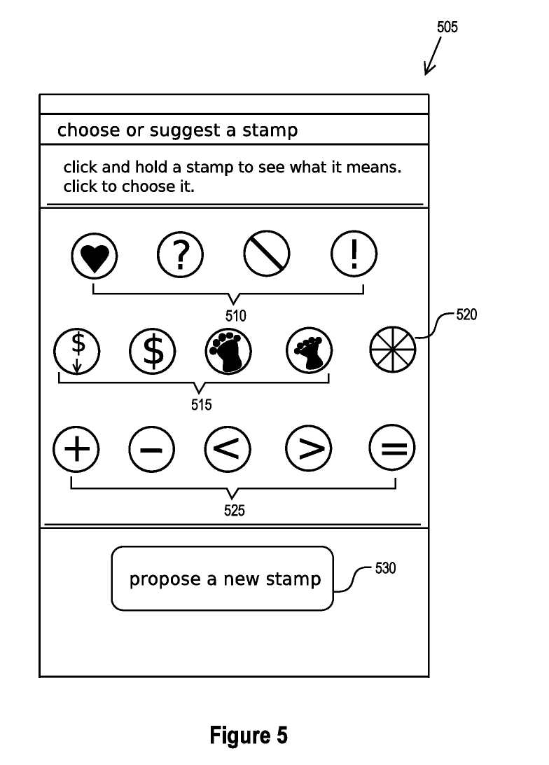

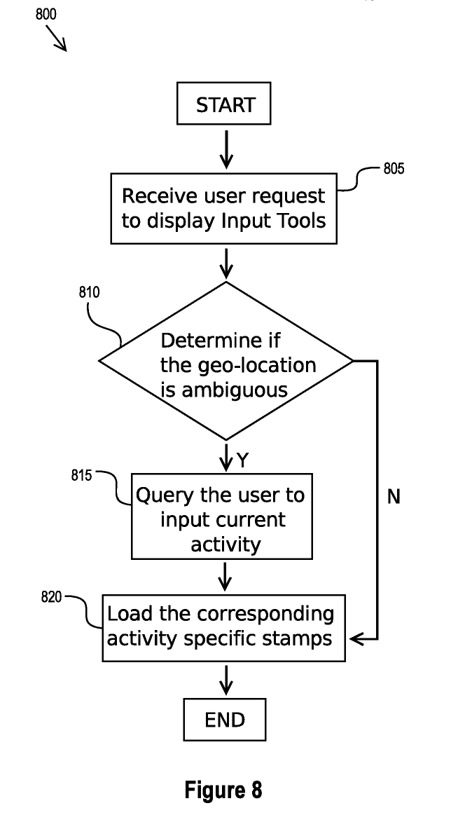

FIGS. 5-7, 9-13 illustrate various example GUIs of an example application of some embodiments of the invention adding input using stamping and free-form sketching type inputs, and FIG. 8 conceptually illustrates a process of determining activity specific stamp input tools.

a. “Stamping”

Stamps are pre-defined symbols that may have data associated with them and allow users to quickly leave sentiments on a photographic image. In some embodiments, three types of stamping tools are available: Universal Stamps, Activity Specific Stamps, and Operator Stamps. In some embodiments, multiple stamps can be selected and inputted on an image one at a time to convey compound sentiments. Written or spoken text can be added to describe a stamp after selecting a stamp and inputting it on a photographic image in some embodiments, and may be displayed as a text overlay when the user touches the selected stamp that has the added description.
i. Universal Stamps

In the example GUI 105 in FIG. 2, the user's four most frequently used universal stamps are displayed as separate touch selectable buttons in Stamp Tools 140. A person skilled in the arts will understand that the most frequently used stamps displayed in GUI 105 as Stamp Tools 140 may include more or less than four stamps and may also include other types of stamps, including but not limited to, activity-specific stamps, operator stamps, or accepted proposed stamps and is dynamic.

Additional Universal Stamps can be displayed by selecting More Stamps Button 145 in FIG. 2. FIG. 5 shows an example input tools GUI 505 after More Stamps Button 145 is selected. All available Universal Stamps are displayed in example GUI 505 under Universal Stamps Tool 510. In some embodiments, these Universal Stamps are always displayed when selecting More Stamps Button 145 in FIG. 2 and are not activity dependent.

Returning to the example in FIG. 5, Universal Stamps are displayed as Universal Stamps Tool 510 and Color Stamp Tool 520. In the example in FIG. 5, Universal Stamps Tool 510 displays as a row of user-selectable buttons that include but are not limited to the following stamps from left to right: a heart stamp meaning “I like this,” a question mark stamp meaning “I have a question about this,” a circle with a slash through it stamp meaning “I don't like this,” and an exclamation point stamp meaning “I have a comment about this.” In some embodiments, selecting one of the stamps from Universal Stamps Tool 510 prompts the application to display GUI 105 again from FIG. 2 so the user can place the Universal Stamp selected on the photographic image in Image Creator Box 110.

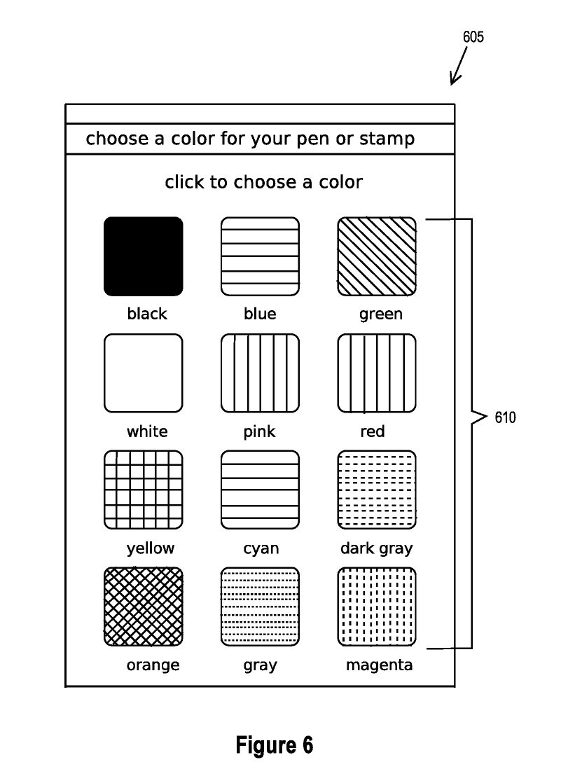

Returning again to FIG. 5, in some embodiments, selecting Color Stamp Tool 520 prompts the application to display the example GUI 605 in FIG. 6. In some embodiments, GUI 605 displays individual user-selectable color buttons illustrated in FIG. 6 as Color Input Tools 610. In some embodiments, selection of a color button prompts the application to display GUI 105 again in FIG. 2 so the user can then place the selected color as a corresponding color stamp on the photographic image in Image Creator Box 110.

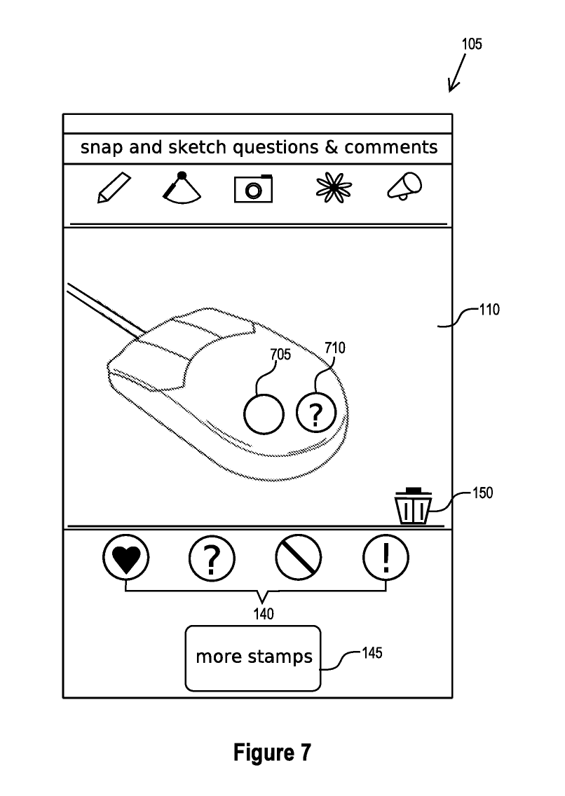

FIG. 7 illustrates example GUI 105 after the user selects the . question mark stamp button from Stamp Tools 140 and places it on the photographic image as Stamp 705 in Image Creator Box 110 by touching his finger on the touch screen where the user wants to place the stamp. Also, the user in example FIG. 7 selects More Stamps Button 145 which prompts the application to display GUI 505 from FIG. 5. Then the user selects Color Stamp Tool 520 which prompts the application to display GUI 605 from FIG. 6. Finally, the user selects the “white” color button from Color Input Tools 610 in GUI 605 in FIG. 6 and places it on the photographic image in Image Creator Box 110 as Stamp 710 in the example GUI 105 in FIG. 7. In the example of FIG. 7, this image now carries the sentiment “Question: does this mouse come in the color white?” The user can then click Action Button 115 to submit the pictorial data to the application server.

In some embodiments, once Action Button 115 is selected, the pictorial data in Creator Box 110 is submitted to the application server, which will process the question-type sentiment or remark-type sentiment inputs with the photographic image. In some embodiments, the application server will multicast remark-type sentiments to social media platforms (e.g. Twitter and Facebook) and store them on the application server. In some embodiments, for question-type sentiments, the application server will determine if it can return an answer to the user using either machine intelligence (e.g. google, yelp-type data) or human intelligence (e.g. search all user submitted remark-type sentiments stored in the application storage for a responsive remark-type sentiment first, then multicast it to social media platforms like Twitter and Facebook or deliver it to targeted people in the application server network who may have the expertise to answer it).
ii. Activity Specific Stamps

FIG. 8 conceptually illustrates how the application server determines which Activity Specific Stamps to display in the example GUI 505 in FIG. 5. After the process receives (at 805) a user request to display input selection tools, it then determines (at 810) whether the geolocation is ambiguous. In some embodiments, the application may determine if the user's geolocation is ambiguous in near-real time when the photographic image used is also taken at around the same time. In some embodiments, the application may try to determine if geolocation is ambiguous using stored geolocation information in a photographic image if the photographic image used is selected from a stored collection of images on the application device.

If the application determines that the geolocation is not ambiguous, then the process can determine (at 820) if the user is engaged in an activity that has Activity Specific Stamp Tools available and load the corresponding Activity Specific Stamps Tool 515 in example GUI 505, as illustrated in FIG. 5. If the process determines (at 810) that the user's geolocation is ambiguous, the process will prompt the application to send a query to the user to manually input the user's current activity. Then the process determines (at 820) if the user inputted an activity that has available Activity Specific Stamps, and will similarly load the corresponding Activity Specific Stamps Tool if available in GUI 505.

In the example of FIG. 5, Activity Specific Stamps Tool 515 displays stamp buttons for the activity “shopping,” which include but are not limited to stamps for: on sale (represented by a dollar sign over an arrow pointing down), price (represented by a dollar sign), item runs big (represented by a large foot image), and item runs small (represented by a small foot image).

In the example in FIG. 5, the user may have taken a picture of an item in a department store and, based on the user's geolocation at that time, the application recognizes that the user was in a retail store and determines that she is probably engaged in the activity of shopping. Then the process will load the Activity-Specific Stamps Tool 515 for shopping. In another example, the user may have taken a picture of an item in a small boutique store that the application through the process in FIG. 8 could not unambiguously determine was a retail store because it was not a recognizable geolocation. Then the application would prompt the user to input the activity he or she was doing. If he or she responds with shopping, the process will also load the Activity-Specific Stamps Tool 515 for shopping.

A person of ordinary skill in the art recognizes that shopping is only one example of possible Activity-Specific Stamps Tool 515 that can be displayed in GUI 505. As another example, dining activity could be determined for a user using the example application in a restaurant and a different set of Activity Specific Stamps for dining would be displayed in Activity-Specific Stamps Tool 515 in GUI 505, if available. Other example activities include but are not limited to sporting events and news-related events.
iii. Operator Stamps

Stamp calculus uses operator stamps to describe relationships in some embodiments between one or more stamps within a stamp chain to create meaningful links between a stamp chain and the photographic image it describes.

Returning to the example in FIG. 2, when the user selects More Stamps Button 145, GUI 505 in FIG. 5 is displayed. Operator Stamps Tool 525 in GUI 505 displays a row of available operator stamps to build stamp chains using stamp calculus. In some embodiments, such operators include, but are not limited to, an addition operator (+), a subtraction operator (−), a less than operator (<), a greater than operator (>), and an equal operator (=). These operator stamps can be used in a variety of combinations between two or more stamps to define relationships between the stamps. In some embodiments, the operator stamps can be used in a variety of combinations between two or more stamps and or free sketches or other images and the terms stamps, sketches, or other images may be used interchangeably in those instances.

The addition operator (+) requires two or more stamps and signifies a sentiment about the combination of stamps. The subtraction operator (−) requires two or more stamps and signifies a sentiment about one but not the other stamp. The less than operator (<) requires two stamps and signifies that the stamp on the left has lesser weight than the stamp on the right. The greater than operator (>) requires two stamps and signifies that the stamp on the left has greater weight than the stamp on the right. The equal operator (=) requires two or more stamps and conveys the idea that the stamps represented by the stamp chain are of equal value.

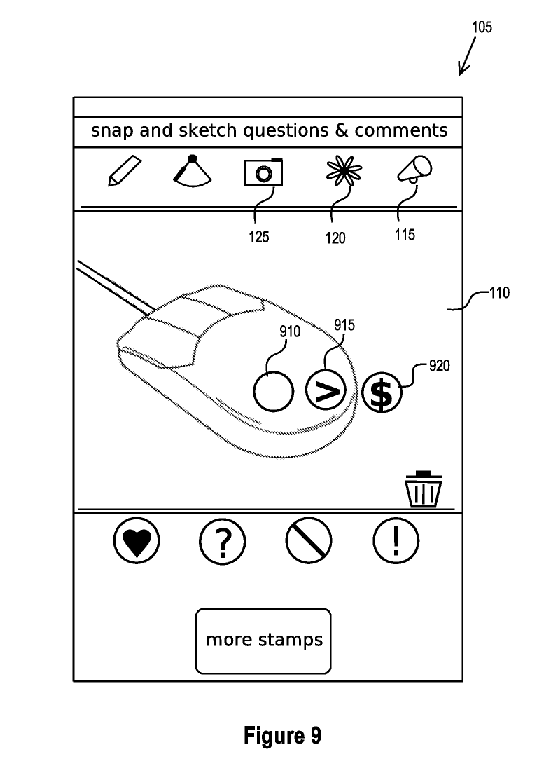

FIGS. 9-13 illustrate GUI 105 in which the user creates example stamp calculus chains on two different photographic images. FIG. 9 shows an example GUI 105 with a photographic image captured in near-real time using Action Button 125 displayed in Image Creator Box 110. Added on the image is an example stamp chain that includes two stamps separated by an operator stamp. The user has selected and placed a white color stamp 910 to the left of a greater than (>) operator stamp 915, and then placed an activity-specific price stamp 920 to the right of that. After creating the stamp chain, the user can select Action Button 115 to submit all the pictorial data in Creator Box 110 to the application, and the application server can process the stamp chain and understand it to mean that for the photographic image sent, white color is more important to the user than price, and will look for the item in white for the user, no matter the cost of the item.

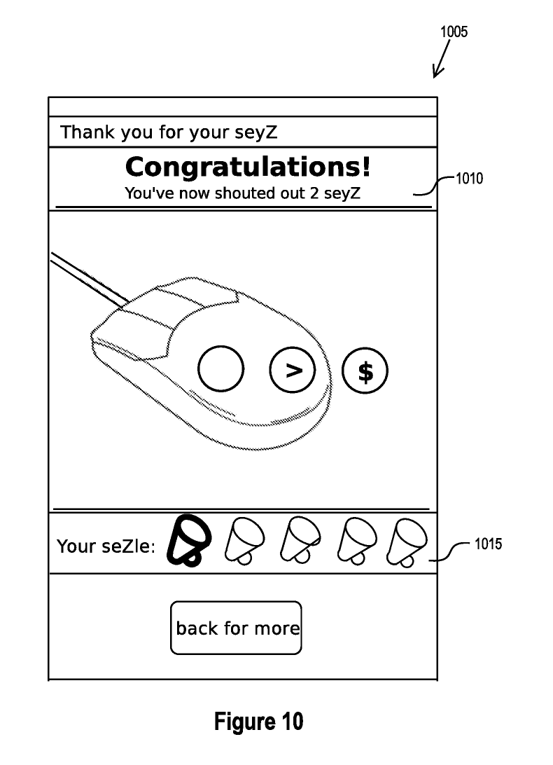

FIG. 10 illustrates a confirmation GUI 1005 of some embodiments that provides a confirmation that the pictorial data in Creator Box 110 was submitted to the application. In some embodiments, GUI 1005 also includes a submission counter display area 1010 that shows the user how many total submissions the user has entered, and a score display area 1015 show the user's affinity rating with the application. In some embodiments, the user's affinity rating is calculated based on the user's participation in using the application (e.g. the number of user inputs submitted per activity period) and the level of conversation that the user's participation generates (e.g. how many responses are generated from broadcasting a user's submissions on a social media platform, how responsive a user's submissions are to answering other users' question-type remarks, etc).

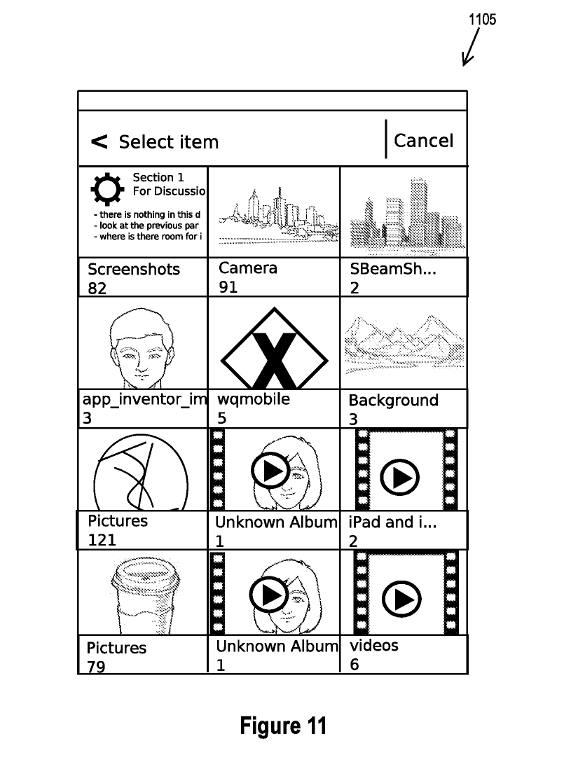

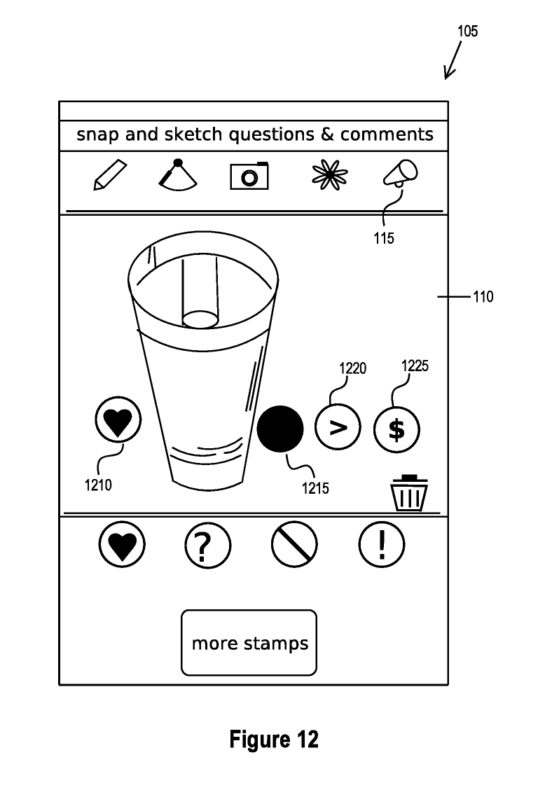

FIG. 11 illustrates an example GUI 1105 that displays an application device's stored photos. GUI 1105 is displayed after Action Button 120 has been selected in FIG. 1. In some embodiments, all stored photos in the application device's photo storage space (e.g. photo storage folder) will be displayed as touch selectable images. In the example illustrated in FIG. 12, a picture has been selected from the example GUI 1105 and is loaded in GUI 105 in Image Creator Box 110. The user has also selected Universal Stamp 1210 and added it to the Image Creator Box 110 on the photo, as well as created a stamp chain. In the example stamp chain, the user has added a black color Stamp 1215 to the left of a greater than (>) operator Stamp 1220, and an activity-specific price Stamp 1225 to the right of Stamp 1220. The example stamp chain conveys the sentiment finding the cup in black is more important to the user than the price of the cup.

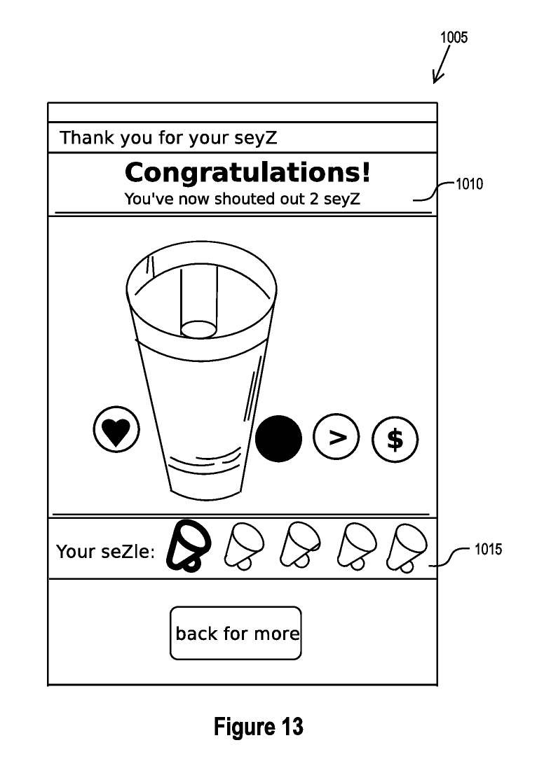

FIG. 13 shows an example confirmation GUI 1005 once the user selects Action Button 115 in FIG. 12 to submit the pictorial data in Image Creator Box 110 to the application server. Similarly to FIG. 10, GUI 1005 also includes a submission counter display area 1010 that shows the user how many total submissions the user has entered, and score display area 1015 showing how useful their submissions are, in some embodiments.

The examples given in FIGS. 9-13 are merely an example and not exhaustive as to how to create stamp chains. One of ordinary skill in the art will realize that there are many different ways to create stamp chains and relationships, and the invention is not limited to the embodiments set forth.

b. Free-Form Sketching

Free-form sketching utilizes free-hand drawn lines and shapes directly onto a photographic image to convey sentiment. In some embodiments, free-form sketches can add emphasis where arrows or circles are sketched to draw attention to a portion of the photographic image. Free-form sketches can also be used in some embodiments to free-hand write symbols, words, or phrases on the photographic image. In some embodiments, free-form sketches are made using a finger on a personal mobile device's touch screen. Returning to the example in FIG. 2, the user can add free-form sketching input to the photographic image in Image Creator Box 110 by selecting Action Button 135 to choose a free-form sketch pen tool. A user selection of Action Button 135 reveals GUI 605 in FIG. 6 and the user can select a pen color from Color Input Tools 610 to sketch with.

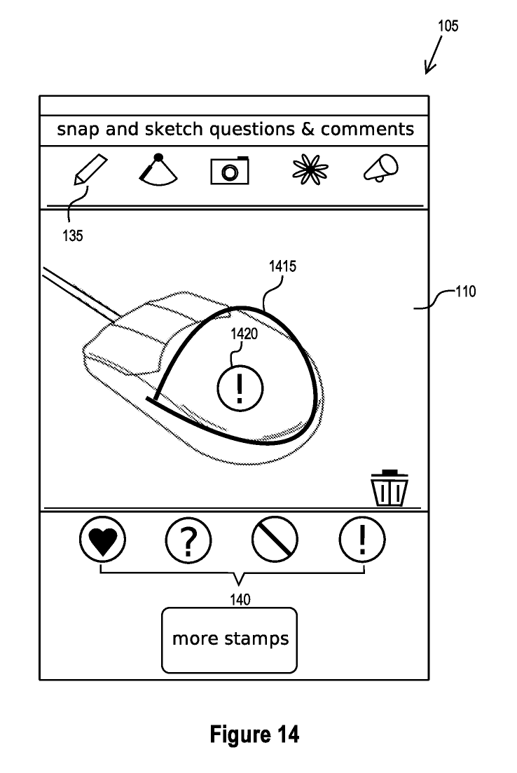

FIG. 14 illustrates an example GUI 105 after the user selects Action Button 135, a pen color, and free-form sketches a circle around the manufacturer's name on the photographic image of a computer mouse. In this example, the free-form sketched circle is displayed as Sketch 1415. In addition, the user in the example of FIG. 14 has selected an exclamation point stamp (meaning I have a comment) from Stamp Tools 140 and placed it on the photographic image over the manufacturer's name. In this example, this is displayed as Stamp 1420.

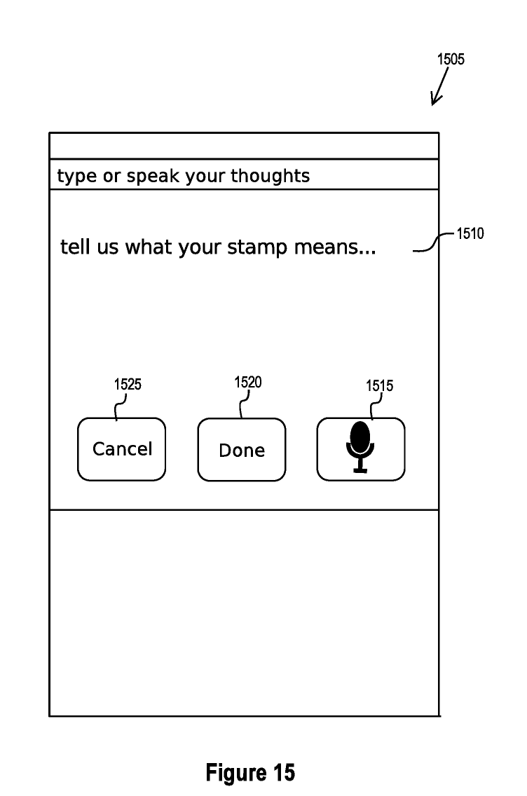

In some embodiments, the user can hold down his finger on a stamp after it has been placed into Image Creator Box 110 to add spoken or written text explanations behind the stamp. FIG. 15 illustrates a comment GUI 1505 that is displayed after the user holds down a stamp in Image Creator Box 110. In some embodiments, comment GUI 1505 includes Text Box 1510 and Talk Button 1515.

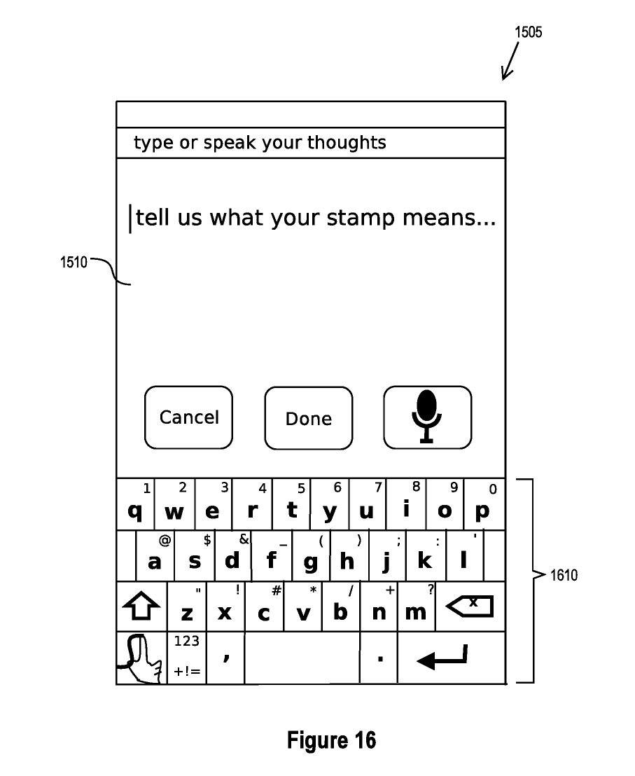

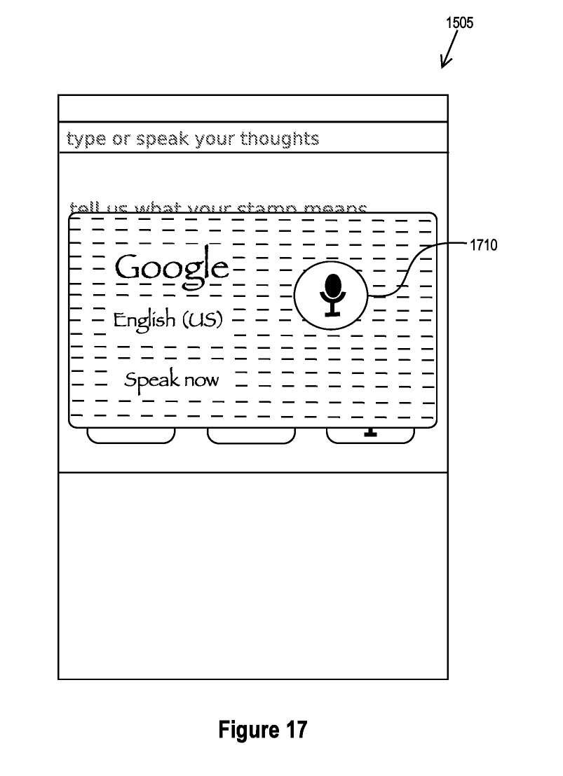

FIG. 16 displays comment GUI 1505 after the user touches Text Box 1510 to enter written text and displays a touch screen Keyboard Tool 1610. The user can use the touch screen keyboard tool to enter written text in Text Box 1510 and add explanation or comments to go with the stamps. FIG. 17 displays comment GUI 1505 after the user selects Talk Button 1515 in FIG. 15 and displays Talk Tool 1710. In some embodiments Talk Tool 1710 uses the built-in microphone on the application device to record what the user says and converts it from natural language to text.

Returning to comment GUI 1505 in FIG. 15, once the user is finished added written or spoken text, the user can select Done button 1520 to prompt the application to return to GUI 105 in FIG. 14. In some embodiments, comment GUI 1505 in FIG. 15 includes Cancel Button 1525 that the user can select at any time to cancel adding a comment to the selected stamp and prompt the application to return to GUI 105 in FIG. 14 immediately.

### III. Proposing New Stamps

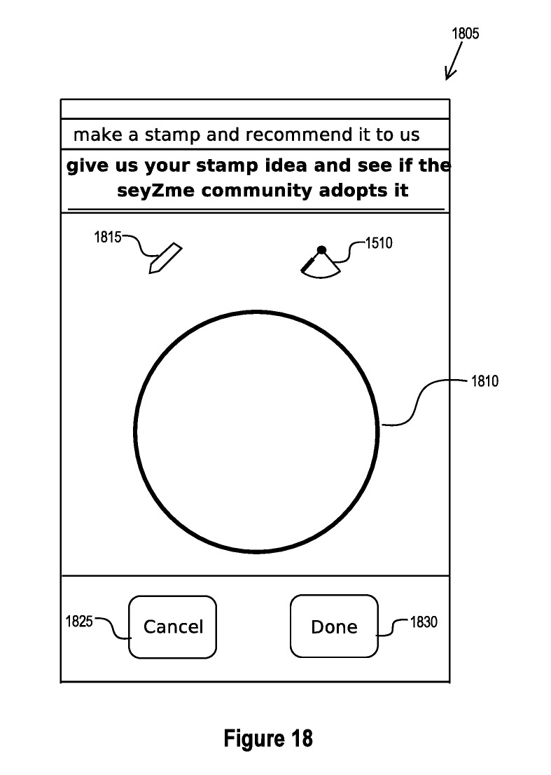

Some embodiments of the invention provide GUI tools for the user to propose new stamps to add to the application. Any user may propose a new stamp and submit it to the application. In some embodiments, the proposed stamp may be accepted through a voting process. In some other embodiments, the proposed stamp may be added and promoted by paying a fee. FIGS. 18-23 illustrate an example of the process of proposing a new stamp for voting.

Returning to the example GUI 505 in FIG. 5, the user can select “propose a new stamp” button 530. In some embodiments, selecting “propose a new stamp” button 530 displays the example GUI 1805 in FIG. 18. The example GUI 1805 includes Sketch Box 1810, Sketch Tool 1815, Eraser Tool 1820, Done Button 1825, and Cancel Button 1830.

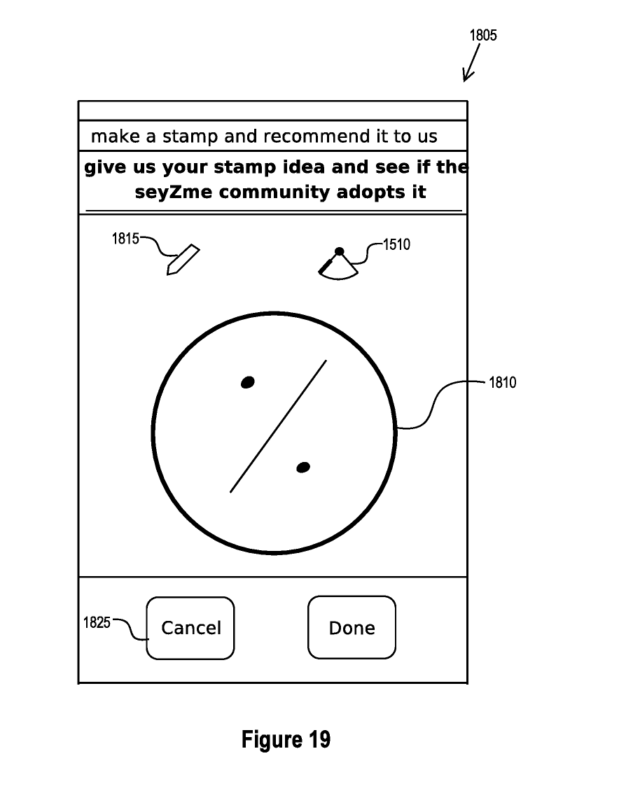

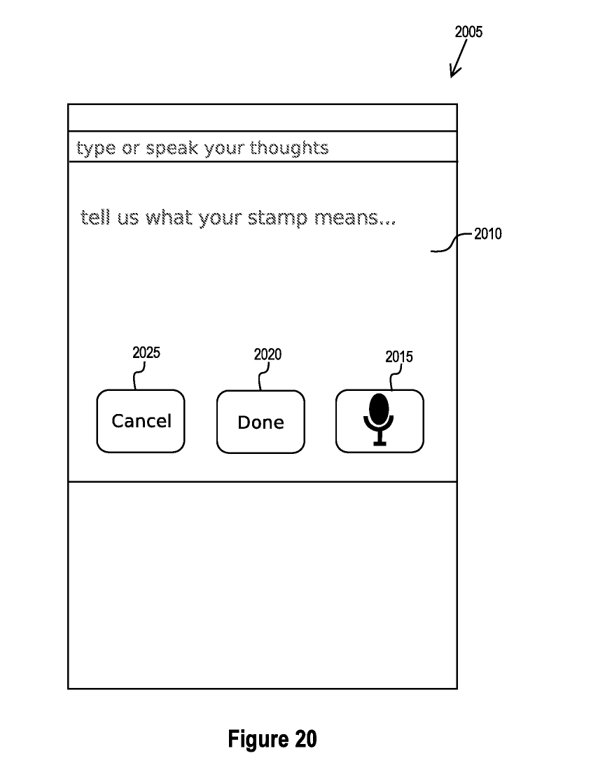

FIG. 19 illustrates GUI 1805 after the user selects Sketch Tool 1815 and draws a stamp image proposal in Sketch Box 1810. The user can select Eraser Tool 1820 to clear all drawings in Sketch Box 1810 in some embodiments and select Done Button 1825 when the user has finished drawing. In some embodiments, the application will prompt the user to enter a description of the proposed new stamp once the user selects the Done Button 1825. FIG. 20 illustrates an example comment GUI 2005 that is displayed after the Done Button 1825 has been selected. GUI 2005 includes Text Box 2010, Talk Button 2015, Done Button 2020, and Cancel Button 2025.

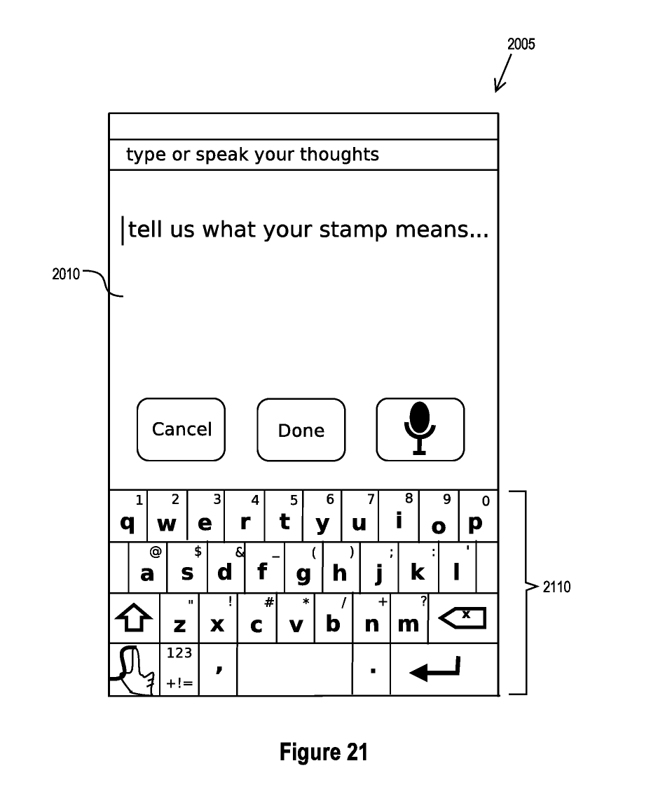

Upon selecting Text Box 2010, a Keyboard Tool 2110 is introduced in some embodiments as a touch screen overlay in GUI 2005 as illustrated in FIG. 21. The user can use Keyboard Tool 2110 to enter written text in Text Box 1510 to describe what the proposed new stamp means.

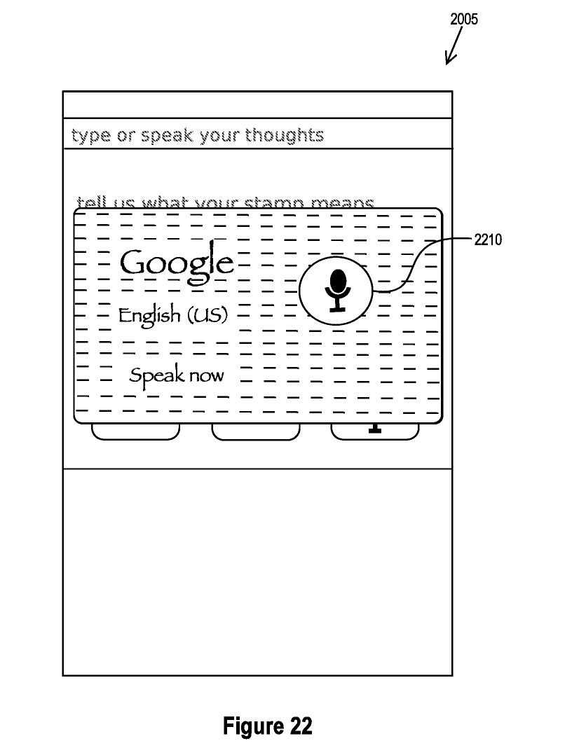

Returning to FIG. 20, the user can select Talk Button 2015 in some embodiments to describe what the proposed new stamp means using spoken text. Upon selecting Talk Button 2015, a Talk Tool 2210 is introduced as an overlay in GUI 2005 as illustrated in FIG. 22. In some embodiments Talk Tool 2210 uses the built-in microphone on the application device to record what the user says and converts it from natural language to text.

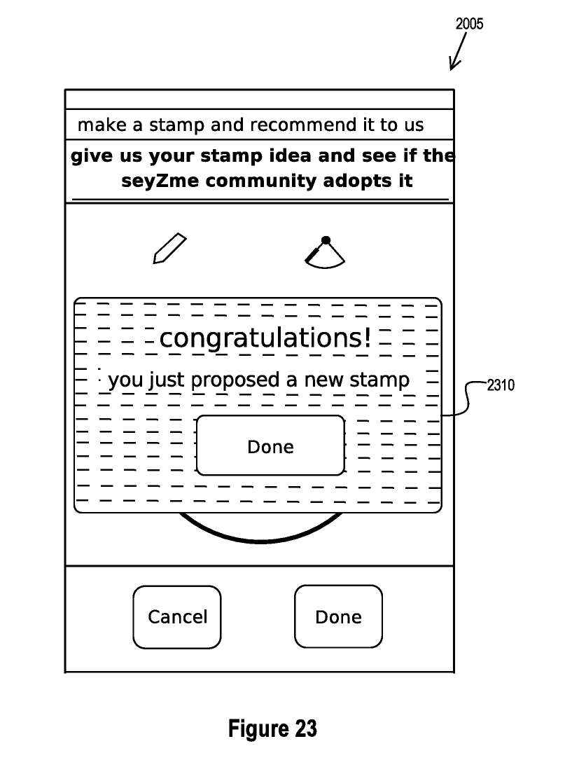

Once the user is finished explaining what the proposed new stamp means through written or spoken text, the user can select Done Button 2020 to submit the proposal to the application. FIG. 23 illustrates GUI 2005 after Done Button 2020 is selected and displays a confirmation message 2310 that the proposal was received by the application. In some embodiments, the application will send all proposed new stamps to the server for processing and quality checking to prepare for the voting process by other application users.

In conjunction with the new stamp proposal capabilities described above, some embodiments provide the capabilities to create new sponsored stamps. In some embodiments, these stamps are a special category of stamps that are directly added to the application by paying a fee without being voted on by other users. Different entities (e.g. people, companies, organizations) can use these special stamps for different purposes such as to advertise products or services, to perform market research, etc. In some embodiments these sponsored stamps are displayed more prominently, apart from other non-sponsored stamps. In some other embodiments, they may be displayed elsewhere along with other non-sponsored stamps.

### IV. Computer System

FIG. 24 illustrates an example computer system for implementing various disclosed embodiments. Many of the above-described example application system components and engines are implemented as software processes that are specified as a set of instructions recorded on a machine-readable medium (also referred to as computer readable medium). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc.

In this specification, the term “software” is meant in its broadest sense. It can include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention.

FIG. 24 illustrates a computer system with which some embodiments of the invention are implemented. Such a computer system includes various types of computer readable mediums and interfaces for various other types of computer readable mediums. Computer system 2400 includes a bus 2405, a processor 2410, a system memory 2415, a read-only memory (“ROM”) 2420, a permanent storage device 2425, input devices 2430, and output devices 2435. The components of the computer system 2400 are electronic devices that automatically perform operations based on digital and/or analog input signals.

One of ordinary skill in the art will recognize that the computer system 2400 may be embodied in other specific forms without deviating from the spirit of the invention. For instance, the computer system may be implemented using various specific devices either alone or in combination. For example, a mobile device (e.g. cell phone, tablet, etc) may include the input and output devices 2430 and 2435, while a remote personal computer (“PC”) may include the other devices 2405-2425, with the mobile device connected to the PC through a cellular network that accesses the PC through its network connection 2440.

The bus 2405 collectively represents all system, peripheral, and chipset buses that communicatively connect the numerous internal devices of the computer system 2400. For instance, the bus 2405 communicatively connects the processor 2410 with the ROM 2420, the system memory 2415, and the permanent storage device 2425. From these various memory units, the processor 2410 retrieves instructions to execute and data to process in order to execute the processes of the invention.

The ROM 2420 stores static data and instructions that are needed by the processor 2410 and other modules of the computer system. The permanent storage device 2425, on the other hand, is a read-and-write memory device. This device is a non-volatile memory unit that stores instructions and data even when the computer system 2400 is off. Some embodiments of the invention use a mass-storage device (such as a magnetic or optical disk and its corresponding disk drive) as the permanent storage device 2425.

Other embodiments use a removable storage device (such as a floppy disk or ZIP® disk, and its corresponding disk drive) as the permanent storage device. Like the permanent storage device 2425, the system memory 2415 is a read-and-write memory device. However, unlike storage device 2425, the system memory is a volatile read-and-write memory, such a random access memory. The system memory stores some of the instructions and data that the processor needs at runtime. In some embodiments, the invention's processes are stored in the system memory 2415, the permanent storage device 2425, and/or the ROM 2420. Together or separate, the above mentioned memories and storage devices comprise the computer readable medium of the computer system on which the above described processes are stored and executed from, and the content, pictorial data, stamps, and stamp chains used by the processes are stored.

The bus 2405 also connects to the input and output devices 2430 and 2435. The input devices enable the user to communicate information and select commands to the computer system. The input devices 2430 include alphanumeric keyboards, sketching devices, and pointing devices. The output devices 2435 display images generated by the computer system. For instance, these devices display a graphical user interface. The output devices include printers and display devices, such as cathode ray tubes (CRT) or liquid crystal displays (LCD).

Finally, as shown in FIG. 24, bus 2405 also couples computer 2400 to a network 2440 through a network adapter (not shown). In this manner, the computer can be a part of a network of computers (such as a local area network (“LAN”), a wide area network (“WAN”), or an Intranet, or a network of networks, such as the internet. For example, the computer 2400 may be coupled to a web server (network 2440) so that a web browser executing on the computer 2400 can interact with the web server as a user interacts with a graphical user interface that operates in the web browser. Any or all components of computer system 2400 may be used in conjunction with the invention.

While the invention has been described with reference to numerous specific details, one of ordinary skill in the art will recognize that the invention can be embodied in other specific forms without departing from the spirit of the invention. For instance, a person of ordinary skill in the art would realize that the invention may be practiced in several different operating environments such as Microsoft Windows®, UNIX®, Linux, etc.

What is claimed is:

1. A method for defining a user interface (UI) for specifying stamps for a piece of content, the method comprising:
defining a first set of UI items for selecting a first stamp;
defining a second set of UI items for selecting a second stamp; and
defining a third set of UI items for selecting a relationship operator stamp that identifies a relationship between the first stamp and the second stamp.

2. The method of claim 1, wherein the first set of UI items comprises a list of the user's most frequently used stamps.

3. The method of claim 2, wherein the list of user's most frequently used stamps is dynamic and may change based on the user's history of selected stamps.

4. The method of claim 1, wherein the second set of UI items comprises a list of activity-specific stamps defined by determining the user's geolocation.

5. The method of claim 1, wherein the third set of UI items comprises a list of different operator stamps for identifying the relationship between the first stamp and the second stamp.

6. The method of claim 1 further comprising defining a display area for displaying a text representation of the relationship between the first stamp and the second stamp.

7. The method of claim 1, wherein at least one of the first, second, and third stamps is a sponsored stamp.

8. A non-transitory computer readable medium storing a computer program for execution by at least one processor, the computer program comprising sets of instructions for:
receiving identification of a first stamp;
receiving identification of a second stamp;
receiving identification of a relationship operator stamp; and
defining a link of a stamp chain by creating a relationship between the first stamp and the second stamp using the relationship operator stamp to describe the relationship between the first stamp and the second stamp.

9. The non-transitory computer readable medium of claim 8, wherein at least one of the first, second, and third stamps is a sponsored stamp.

10. A method of defining a UI for proposing a new stamp to add to the computer program, said method comprising:
defining a first set of UI tools for receiving user sketch input; and
defining a second set of UI tools for receiving user text input.

11. The method of claim 10, wherein the second set of UI tools allows the user to input a comment using written text.

12. The method of claim 10, wherein the second set of UI tools allows the user to input a comment using spoken text.
